(19) United States
(12) Patent Application Publication
(10) Pub. No.: US 2009/0296942 A1
(43) Pub. Date: Dec. 3, 2009

(54) CONCEPT FOR SECURING AND VALIDATING CLIENT-SIDE STORAGE AND DISTRIBUTION OF ASYNCHRONOUS INCLUDES IN AN APPLICATION SERVER ENVIRONMENT

(75) Inventors: Erik J. Burckart, Raleigh, NC (US); TODD E. KAPLINGER, Raleigh, NC (US); Rohit D. Kelapure, Morrisville, NC (US); Erinn E. Koonce, Durham, NC (US); Maxim A. Moldenhauer, Durham, NC (US)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/128,850

(22) Filed: May 29, 2008

(51) Int. Cl. H04L 9/30

(52) U.S. Cl. 380/282

(57) ABSTRACT

The ability to leverage a publish/subscribe functionality in an application server environment has allowed the storage of cached entries to be stored over multiple clients rather than on a single application server, freeing up valuable resources. However, in this arrangement it is not possible for the originating server to validate shared content originating from client-side storage. The present invention provides a system and method for securing and validating content from asynchronous include request utilizing public key cryptography and hashing functions.

### FIELD OF THE INVENTION

The present disclosure relates generally to a method and system for securing and validating the client-side storage of content from asynchronous include requests in an application server environment.

### DESCRIPTION OF BACKGROUND

In the traditional application server environment, entire pages are cached by an application server and each client must return to the application server to obtain these pages. With the advent of new Web 2.0 technologies, pages are becoming increasingly fragmented, resulting in an increase in the number of cached entries and a decrease in the likelihood that any of those cached fragments will be requested again. By leveraging a publish/subscribe environment, these cached entries can be stored on multiple clients instead of a single server. This frees up server resources and allows the server to act more like a proxy, facilitating indirect communication between multiple clients, than a storage mechanism. Clients have also benefited from this arrangement since there is no longer a need to constantly poll the server for results. A client subscribes to content via an asynchronous include/request, and once subscribed clients are automatically notified when results become available. No additional software is required on the client end as known technologies like Dojo already contain publication/subscribe functionality and dojo.storage and can be utilized to provide a unified method for maintaining cached content on the client.

The prior art method for client-side storage and distribution of asynchronous includes is demonstrated in FIG. 3. In step 301, Client A subscribes to receive the content of asynchronous include result 1. In step 302, Client B also subscribes to receive the content of result 1. An application server, in step 303, processes the aynchronous include result 1 request and sends the content of result 1 to a results server. In step 304, the results server receives result 1 and distributes the content to all subscribed clients (Clients A & B). The content of result 1 is no longer stored on the results server. In step 305, Client C subscribes to receive result 1. In step 306, the results server recognizes that result 1 has already been requested and polls all clients subscribed to it. Client A, in step 307, responds that it still has result 1 and sends the content to the result server. The result server in turns forwards the content of result 1 to Client C. A serious drawback to this method is that the client should never be considered trusted when it comes to sharing data with other clients since the originating server cannot validate the origin of the content or whether the original content has been modified. Therefore systems and methods for securing and validating client-side storage and distribution of content from asynchronous includes are needed.

### SUMMARY OF THE INVENTION

The present invention utilizes public-key cryptography and hashing functions, such as md5 (Message-Digest algorithm 5), to provide validated read only cache content for client-side storage and distribution of asynchronous includes. The invention comprises an application server environment comprising an application server, a results server and one or more client devices.

Request for asynchronous include content are sent from a client device to an application server. If it is an initial request, the application server processes the request and sends the resulting content and a private key for encrypting the content to a results server. The results server encrypts the content using the private key and generates a public key for decrypting the content. The result server then performs a hash function on the encrypted content and stores the hash locally on the results server.

The result server then sends the encrypted content, the public key, and a copy of the hash of the encrypted content to the requesting client. The client stores the encrypted content and the public key in a local cache. The client performs the same hash function of the encrypted content as that performed by the result server and validates its hash with that provided by the results server. If the hashes match, the client decrypts the content using the public key and renders the content in a browser.

If the asynchronous include request was previously requested by another client, the result server sends a copy of the hash of the encrypted content. The results server identifies and request the encrypted content and public key from other clients that have previously requested and stored the content. The results server then sends a copy of the encrypted content and a copy of the public key to the requesting client. The client stores the encrypted content and public key in a local cache. The client then performs the same hash function on the encrypted content as that performed by the results server and validates it against the hash function received from the results server. If the hashes match the client decrypts the content using the public key and renders the content in a browser. If the hashes do not match the result server identifies other clients having the requested content and sends the encrypted content to the client. If there are no clients with this cached content, the application server will execute the request again, generate the content, publish the content to the results server and the result server will provide an encrypted copy and public key for this newly generated copy.

Additional features and advantages are realized through the techniques of the present invention. Other embodiments and aspects of the invention are described in detail herein and are considered a part of the claimed invention. For a better understanding of the invention with advantages and features, refer to the description and to the drawings.

Technical Effects

As a result of the summarized invention it is now possible to secure and validate client-side storage of content from asynchronous include requests in an application server environment.

### BRIEF DESCRIPTION OF THE DRAWINGS

The subject matter which is regarded as the invention is particularly pointed out and distinctly claimed in the claim at the conclusion of the specification. The foregoing and other objects, features, and advantages of the invention are apparent from the following detailed description taken in conjunction with the accompanying drawings in which:

FIG. 1 is a block diagram depicting an exemplary operating environment for implementation of certain exemplary embodiments.

FIG. 2 is a block diagram illustrating a general computer environment of a client computer for use with certain exemplary embodiments.

FIG. 3 is a block diagram illustrating prior art methods for client-side storage and distribution of asynchronous includes.

FIG. 4, comprising FIGS. 4A, 4B and 4C, is flow chart depicting a method for securing and validating client-side storage and distribution of an asynchronous include request in an application server environment, in accordance with certain exemplary embodiments.

The detailed description explains the preferred embodiments of the invention, together with advantages and features, by way of example with reference to the drawings.

### DETAILED DESCRIPTION OF THE INVENTION

The invention is directed to a method for securing and validating client-side storage and distribution of asynchronous includes in an application server environment. The invention allows a client to validate content received from other clients in an application server environment. Turning now to the drawings, in which like numerals indicate like elements throughout the figures, exemplary embodiments of the invention are described in detail.

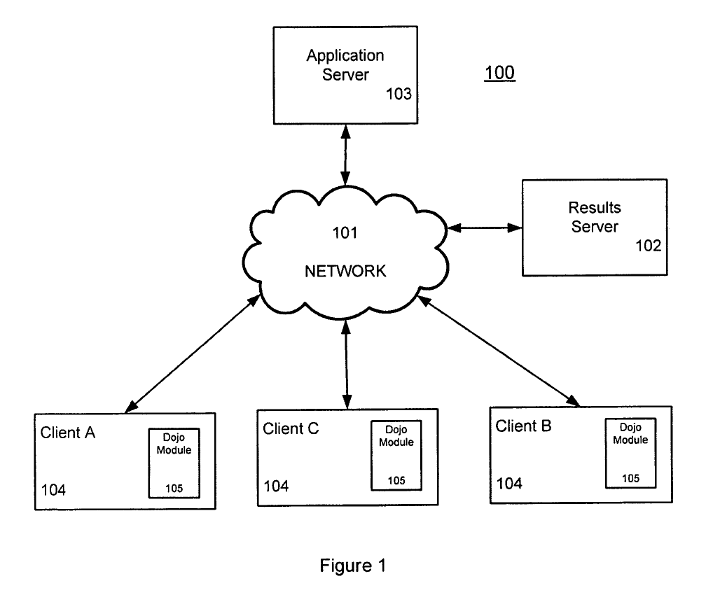

FIG. 1 is a block diagram depicting an exemplary operating environment 100 for implementation of certain exemplary embodiments of the invention. Client devices 104, a results server 102 and application server 103 are interconnected via a network 101. The network includes a wired or wireless telecommunications means by which client devices 104, results server 102 and application server 103 can exchange data. For example, the network 101 can include a local area network (“LAN”), a wide area network (“WAN”), an intranet, an Internet, or any combination thereof. The terms “data” and “information” are used interchangeably herein to refer to text, images, audio, video, or any other forms of information that can exist in a computer-based environment, whether readable by a computer or a person.

Each client device 104 can be any device capable of transmitting and receiving data over the network 101. For example, each client device 104 can be a desktop computer, a laptop computer, a wireless network device, such as a personal digital assistant (PDA), a handheld computer, or any other wired or wireless, processor-driven device.

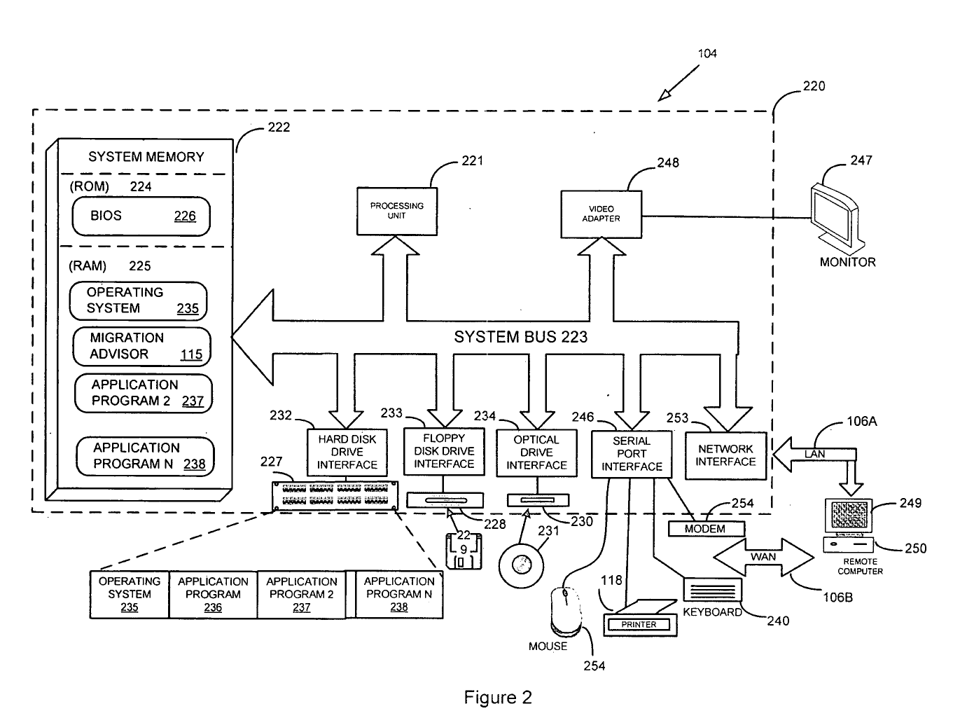

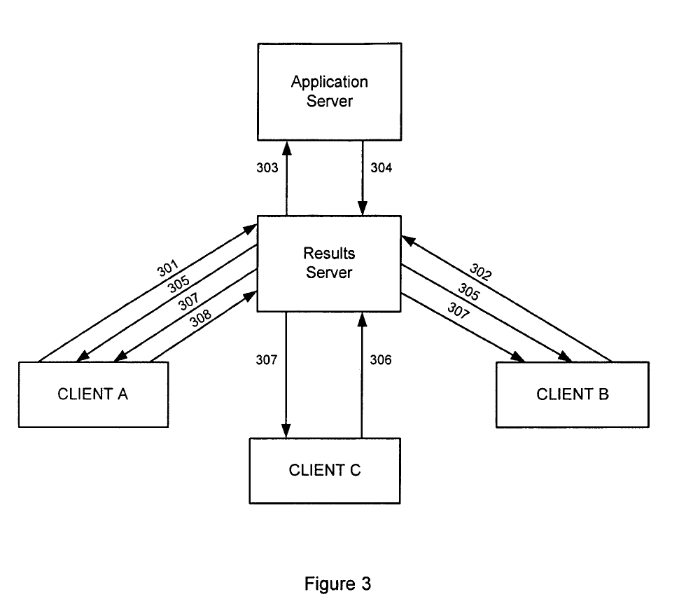

FIG. 2 is a block diagram illustrating a general component architecture for the network device 104, in accordance with certain exemplary embodiments. The network device 104 includes a general-purpose computing device in the form of a conventional computer 220. Generally, the computer 220 includes a processing unit 221, a system memory 222, and a system bus 223 that couples various system components, including the system memory 222, to the processing unit 221. The system bus 223 can include any of several types of bus structures, including a memory bus or memory controller, a peripheral bus, or a local bus, using any of a variety of bus architectures. The system memory 222 includes a read-only memory (“ROM”) 224 and a random access memory (“RAM”) 225. A basic input/output system (BIOS) 226 containing the basic routines that help to transfer information between elements within the computer 220, such as during start-up, is stored in the ROM 224.

The computer 220 also includes a hard disk drive 227 for reading from and writing to a hard disk (not shown), a magnetic disk drive 228 for reading from or writing to a removable magnetic disk 229 such as a floppy disk, and an optical disk drive 230 for reading from or writing to a removable optical disk 231 such as a CD-ROM, compact disk-read/write (CD/RW), DVD, or other optical media. The hard disk drive 227, magnetic disk drive 228, and optical disk drive 230 are connected to the system bus 223 by a hard disk drive interface 232, a magnetic disk drive interface 233, and an optical disk drive interface 234, respectively. Although the exemplary client device 104 employs a ROM 224, a RAM 225, a hard disk drive 227, a removable magnetic disk 229, and a removable optical disk 231, it should be appreciated by a person of ordinary skill in the art having the benefit of the present disclosure that other types of computer readable media also can be used in the exemplary client device 104. For example, the computer readable media can include any apparatus that can contain, store, communicate, propagate, or transport data for use by or in connection with one or more components of the computer 220, including any electronic, magnetic, optical, electromagnetic, infrared, or semiconductor system (or apparatus or device) or propagation medium, such as magnetic cassettes, flash memory cards, digital video disks, Bernoulli cartridges, and the like. The drives and their associated computer readable media can provide nonvolatile storage of computer-executable instructions, data structures, program modules, and other data for the computer 220.

A number of modules can be stored on the ROM 224, RAM 225, hard disk drive 227, magnetic disk 229, or optical disk 231, including an operating system 235 and various application modules 105, 237-238. Application modules 105 and 237-238 can include routines, sub-routines, programs, objects, components, data structures, etc., which perform particular tasks or implement particular abstract data types. Dojo module 105, is a modular open source JavaScript toolkit, or library, for use in the rapid development of JavaScript and/or Ajax-based applications on websites.

A user can enter commands and information to the computer 220 through input devices, such as a keyboard 240 and a pointing device 242. The pointing device 242 can include a mouse, a trackball, an electronic pen that can be used in conjunction with an electronic tablet, or any other input device known to a person of ordinary skill in the art, such as a microphone, joystick, game pad, satellite dish, scanner, or the like. These and other input devices are often connected to the processing unit 222 through a serial port interface 246 that is coupled to the system bus 223, but can be connected by other interfaces, such as a parallel port, game port, a universal serial bus (USB), or the like. A display device 247, such as a monitor, also can be connected to system bus 223 via an interface, such as a video adapter 248. In addition to the display device 247, the computer 220 can include other peripheral output devices, such as speakers (not shown) and a printer 118.

The computer 220 is configured to operate in a networked environment using logical connections to one or more remote computers 249, such as client devices 104 and application servers 103 and results servers 102. The remote computer 249 can be any network device, such as a personal computer, a server, a client, a router, a network PC, a peer device, or other device. While the remote computer 249 typically includes many or all of the elements described above relative to the computer 220, only a memory storage device 250 has been illustrated in FIG. 2 for simplicity. The logical connections depicted in FIG. 2 include a LAN 106A and a WAN 106B. Such networking environments are commonplace in offices, enterprise-wide computer networks, intranets, and the Internet.

When used in a LAN networking environment, the computer 220 is often connected to the LAN 106A through a network interface or adapter 253. When used in a WAN networking environment, the computer 220 typically includes a modem 254 or other means for establishing communications over the WAN 106B, such as the Internet. The modem 254, which can be internal or external, is connected to system bus 223 via a serial port interface 246. In a networked environment, program modules depicted relative to computer 220, or portions thereof, can be stored in the remote memory storage device 250.

It will be appreciated that the network connections shown are exemplary and other means of establishing a communications link between the computers can be used. Moreover, those skilled in the art will appreciate that the network device 104 illustrated in FIG. 2 can have any of several other suitable computer system configurations. For example, the network device 104 may not include certain components, in alternative exemplary embodiments. In certain exemplary embodiments, each of the network server devices 102-103 can include a structure similar to that described previously in connection with the network device 104.

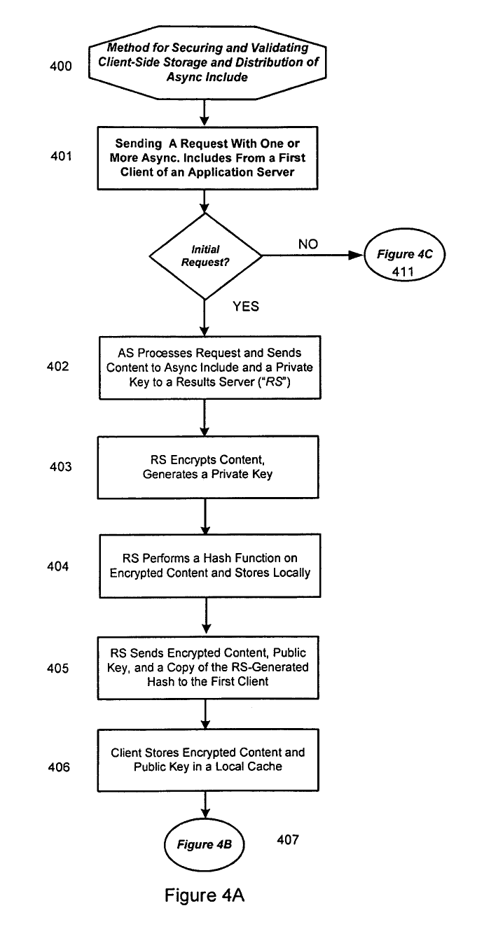

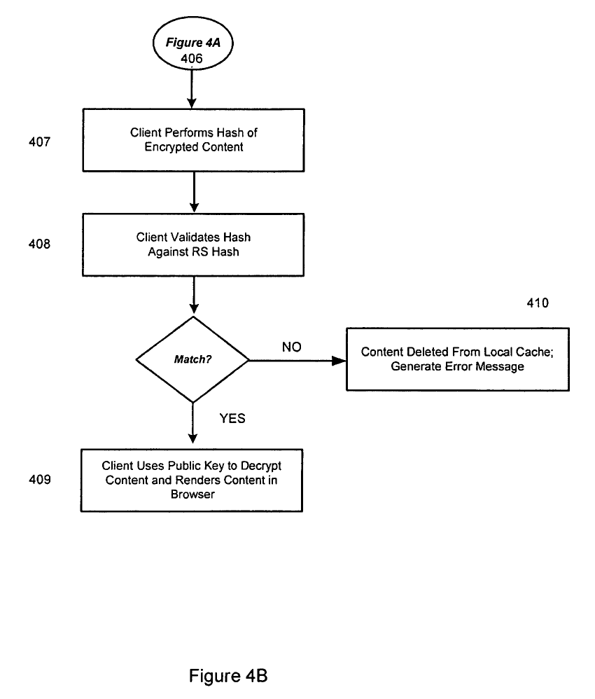

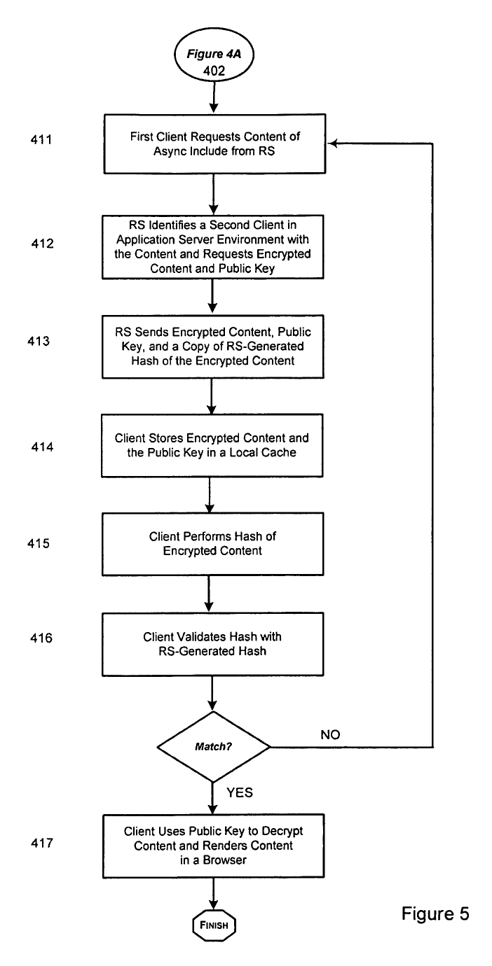

The application server environment 100, the application server 103, results server 102, and client devices 104 are described hereinafter with reference to the methods in FIGS. 4-5.

FIG. 4, which comprises FIGS. 4A, 4B and 4C, is a flow charts depicting a method for securing and validating client side storage and distribution of an aysnchronous include requests, in accordance with certain exemplary embodiments. The exemplary method 400 is illustrative and, in alternative embodiments of the invention, certain steps can be performed in a different order, in parallel with one another, or omitted entirely, and/or certain additional steps can be performed without departing from the scope and spirit of the invention. The method 400 is described hereinafter with references to FIGS. 1-2 and 4.

In step 401, a client device 104 sends a request that contains one or more asynchronous includes to an application server 102.

If the request containing one or more asynchronous includes is an initial request, the application server 102 processes the request and sends the content of the asynchronous includes to a results server 103 in step 402. In step 403, the results server 102 encrypts the content and generates a public key based on the private key from the application server 103.

In step 404, the results server 102 performs a hash function on the encrypted content and stores the hash locally. The hash function can be a md5 hash function (Message-Digest algorithm 5), or similar hash function

In step 405, the result server 102 sends the encrypted content, the public key, and a copy of the results server generated hash to the first client. The encrypted content and public key are no longer stored on the results server 102. The client device 104, stores the encrypted content and public key in a local cache in step 406. For example, if the client device 104 has a dojo module 105, the encrypted content and public key can be stored in the module's associated dojo.storage. Dojo.storage is a client-side storage abstraction that allows web applications to store data on the client-side persistently and securely with a client's permission.

In step 407, the client device 104 performs their own hash function on the encrypted content. However, the hash function must be the same as that used by the results server 102. For example, if the results server performs a md5 hash, the client must also perform a md5 hash of the encrypted content. The client device 104 then validates its own md5 hash against the md5 hash generated by the results server in step 408. If the two hashes match, the client device 104 then decrypts the content and renders the content in a browser in step 409. If the two hashes do not match, the content is deleted from the local cache 107 and an error message is generated in step 410. Alternatively, the request will be sent back to the application server 102 and reprocessed according to steps 402-408.

If the requests is a subsequent request the client device 104 request the content of the asynchronous include from the results server 102 in step 411. In step 412, the results server 102 identifies a second client in the application server environment that has the requested content and request the encrypted content and public key.

In step 413, the results server 102 sends a copy of the encrypted content, a copy of the public key, and a copy of the results server generated hash of the encrypted content to the first client device. The client device 104 stores the encrypted content and public key in a local cache in step 414. As in paragraph 305 the local cache may be dojo.storage component of a dojo module 105.

In step 415, the f client device 104 performs a client generated hash of the encrypted content. The client device 104 then validates the client generated hash against the results server generated hash. If the hashes match, the client device decrypts the content using the public key and renders the content in a browser in step 417. If the hashes do not match, the request is sent to the results server 102 which identifies another client in the application server environment 101 that has the requested content. If another client cannot be found or the requested content cannot be validated after re-processing according to steps 412-416, the request is sent to the application server and processed according to steps 402-408.

The above description of illustrated embodiments of the invention, including what is described in the Abstract, is not intended to be exhaustive or to limit the embodiments to the precise forms disclosed. While specific embodiments of, and examples for, the inventions described herein for illustrative purposes, various equivalent modifications are possible, as those skilled in the art will recognize. These modifications can be made to embodiments of the invention in light of the above detailed description.

What is claimed is:

1. A method for securing and validating client-side storage and distribution of asynchronous include content requests in an application server environment, wherein the application server environment comprises an application server, a results server, and one or more clients, comprising the steps of:
sending an request with one or more asynchronous includes from a first client to an application server;
determining whether the request is an initial request or a subsequent request;
in response to determining the request is an initial request:
processing the request by the application server and sending the content of the one or more asynchronous includes and a private key to the results server; wherein the results server encrypts the content using the private key, generates a public key and performs a results server generated hash of the encrypted content which is stored locally on the results server,
sending the encrypted content, the public key, and a copy of the results server generated hash to the first client from the results server to the first client, wherein the first client stores the encrypted content and public key in a local cache;
performing a first client generated hash of the encrypted content and validating the first client generated hash against the result server generated hash, wherein if the hashes match the content is decrypted using the public key and rendered in a browser;
in response to determining the request is a subsequent request:
requesting the content of the asynchronous include from the result server, wherein the result server identifies a second client in the application server environment that has the content and requests the encrypted content and public key,
sending the encrypted content, the public key, and a copy of the result server generated hash from the result server to the first client, wherein the first client stores the encrypted content and public key in a local cache;
performing a first client generated hash of the encrypted content and validating the first client generated hash against the result server generated hash, wherein if the hashes matches, the first client decrypts the content using the public key and renders the content in a browser.
